(19) United States
(12) Patent Application Publication
(10) Pub. No.: US 2006/0137964 A1
(43) Pub. Date: Jun. 29, 2006

(54) SWITCH DEVICE

(75) Inventor: Chin Sheng Liu, Taipei (TW)

Correspondence Address: G. LINK Co., LTD, 3550 BELL ROAD, Minooka, IL, 60447, US

(73) Assignee: BEHAVIOR TECH COMPUTER CORP.

(21) Appl. No.: 11/021,861

(22) Filed: Dec. 27, 2004

(51) Int. Cl. H01H 19/14

(52) U.S. Cl. 200/336

(57) ABSTRACT

The abstract is amended in the following for being in accordance with the substitute specification: A switch device includes a base member, a rotary mechanism and a vertical actuation mechanism. The rotary mechanism is received in the base member to move a present circular displacement while a hollow handle turning. The vertical actuation mechanism is received in the base member under the rotary mechanism to move a downward preset displacement in the vertical direction for touching button type switches underneath while the rotary mechanism moving.

### FIELD OF THE INVENTION

The present invention relates to a switch device and more particularly to a touch-point displacement in the vertical direction being produced after the switch device being rotationally operated.

### BACKGROUND OF THE INVENTION

The conventional rotary switch is rotationally operated by way of rotational mechanism to allow two or more disconnected electrical nodes touching to each other forming a state of close circuit. Similarly, the conventional push type switch is operated by way of being pressed to allow two or more disconnected electrical nodes touching to each other forming a state of close circuit. The preceding conventional rotary switch and push type switch are provided to perform a function of electrical nodes being able to electrically connect with each other. However, the conventional art concerning the switch does not disclose how the user rotationally operates the switch in the circumferential direction and how the switch is pressed to complete the operation of switch with a moving stroke.

### SUMMARY OF THE INVENTION

An objective of the present invention is to provide a switch, which allows the user rotationally operates the switch in the circumferential direction to result in the switch is pressed to complete the operation of switch with a moving stroke.

In order to achieve the preceding objective, the switch device according to the present invention, which is rotationally operated to produce a touch-point displacement in the vertical direction, includes a base member, a rotary mechanism and a vertical actuation mechanism. The rotary mechanism is received in the base member to produce a present displacement in the circumferential direction during being rotationally operated so as to pressingly contact and move the vertical actuation mechanism. The vertical actuation mechanism is received in the base member to produce a touch-point displacement in the vertical direction after being moved with the rotary mechanism.

### BRIEF DESCRIPTION OF THE DRAWINGS

The detailed description and technical characteristics of the present invention are described together with the drawings as follows:

FIG. 1 is an exploded perspective view of the first embodiment of a switch according to the present invention;

FIG. 2 is another exploded perspective view of the first embodiment of a switch according to the present invention;

FIG. 3 is a top view of the first embodiment of a switch according to the present invention illustrating part of interior thereof;

FIG. 4 is a perspective view illustrating part of the internal structure of the first embodiment of a switch according to the present invention;

FIG. 5 is an assembled sectional view of the first embodiment of a switch according to the present invention;

FIG. 6 is an exploded perspective view of the second embodiment of a switch according to the present invention;

FIG. 7 is another exploded perspective view of the second embodiment of a switch according to the present invention; and

FIG. 8 is an assembled sectional view of the second embodiment of a switch according to the present invention.

### DETAILED DESCRIPTION OF THE INVENTION

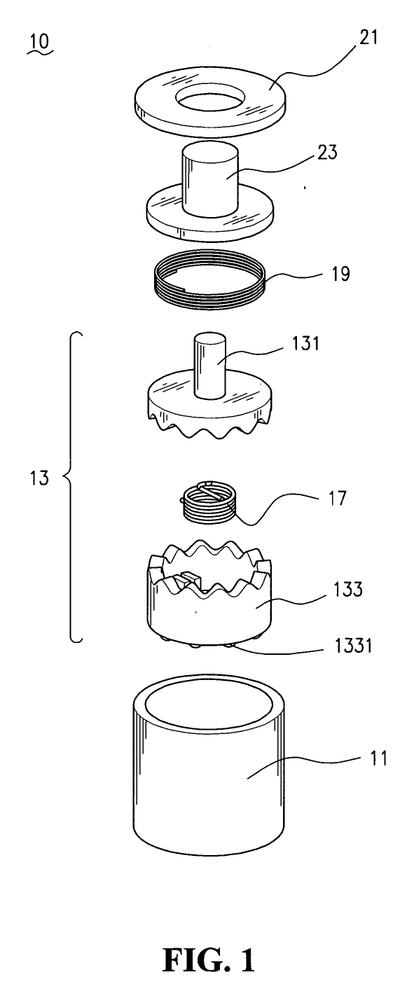

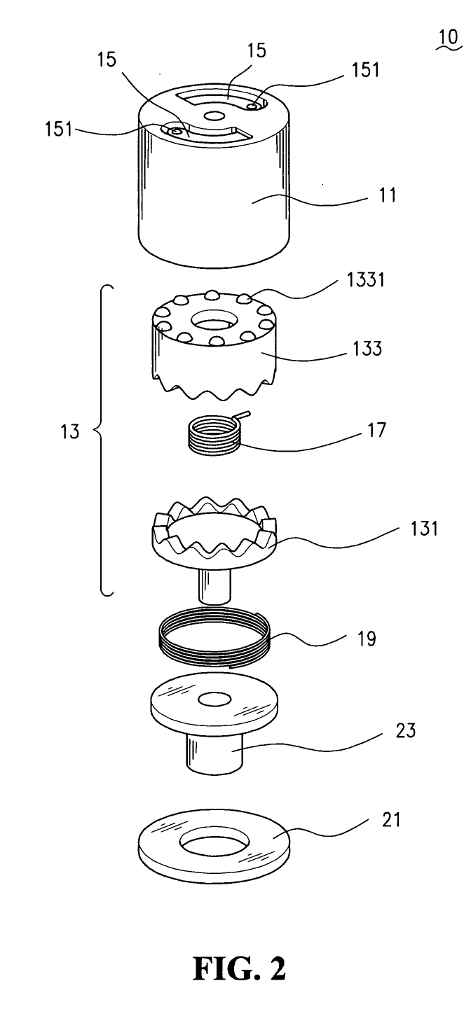

Referring to FIGS. 1 and 2, exploded perspective views of the first embodiment of a switch according to the present invention are illustrated. The switch device 10 comprises a base member 11, a rotary mechanism 13 and a vertical actuation mechanism 15. The rotary mechanism 13 and the vertical actuation mechanism 15 are received in the base member 11 respectively. While in use, the user turns the rotary mechanism 13 to allow the rotary mechanism 13 moving circumferentially such that the rotary mechanism 13 can move a preset displacement. The vertical actuation mechanism 15 can be pressingly contacted with the rotary mechanism 13 during the rotary mechanism 13 moving. Thus, the vertical actuation mechanism 15 moves along with the rotary mechanism 13 to result in a touch-point displacement in the vertical direction. The rotary mechanism 13 is composed of a first ratchet wheel 131 and a second ratchet wheel 132 with a plurality of projections 1331. When the first ratchet wheel 131 rotates, the second ratchet wheel 132 can rotates too due to the ratchet teeth on the first ratchet wheel 131 meshing with the ratchet teeth on the second ratchet wheel 132. Hence, the projections 1331 can move circumferentially and the rotary mechanism 13 can produce the preset displacement. The vertical actuation mechanism 15 is an elastic sheet with a touch point 151 thereon and is disposed in the base member 11. When the projections 1331 displaces along with circumferential movement to approach the elastic sheet, the contact point 151 is pressingly touched by the projections 1331 finally to occur the touch point displacement in the vertical direction. In this way, the function of touch-point displacement can be implemented by the vertical actuation mechanism 15 in practice. The elastic plate 15 can be made of metal or resilient plastic plate.

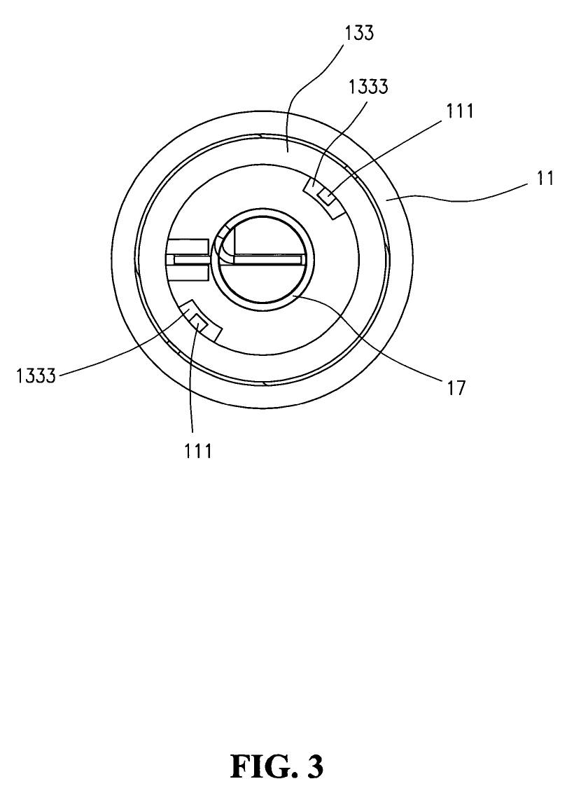

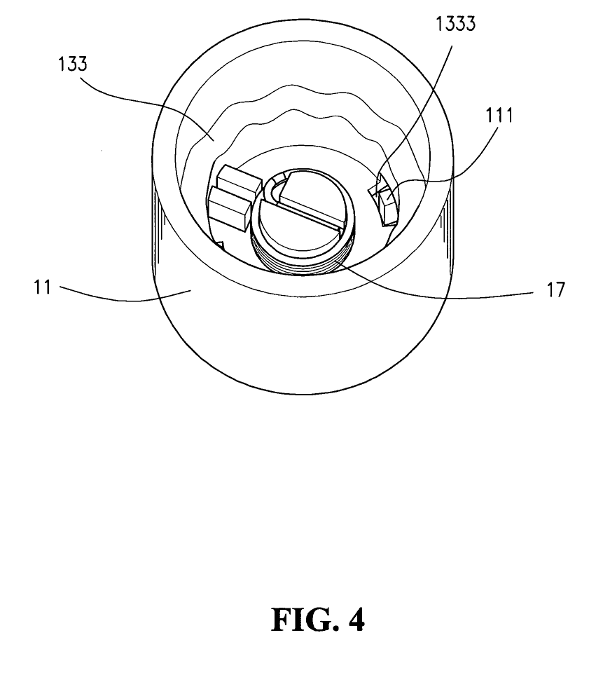

In order to allow the rotary mechanism 13 being capable of moving back to the original position after moving the preset displacement, a torsion spring 17 and a coil spring 19 are provided additionally. It can be seen in FIGS. 3 and 4 that the torsion spring 17 has the two ends thereof being fixedly joined to the second ratchet wheel 133 and the base member 11 respectively. Hence, the second ratchet wheel 133 rotates circumferentially along the inner wall surface of the base member 11 to cause the torsion spring 17 creating a resilient force. When the second ratchet wheel 133 relieves from an external force, which occurs circumferential rotation of the ratchet wheel 133, the resilient force of the torsion spring 17 pulls the second ratchet wheel 133 back to the original position. Referring to FIGS. 1 and 2 again, when an external fore is exerted to rotate the first ratchet wheel 131, the first ratchet wheel 131 moves upward to press the spring 19 and the spring 19 produce a downward resilient force. Once the external force is relieved or the first ratchet wheel 131 rotates a pitch of the ratchet teeth, the resilient force of the spring 19 can pull the first ratchet wheel 131 back the original position thereof.

In order to define magnitude of the preset displacement done by the rotary mechanism 13, the second ratchet wheel 133 is added with a rotating groove 1333 and a locating rib 111. The locating rib 111 is attached to the base member 11 and pass through the rotating groove 1333. When the second ratchet wheel 133 rotates in the circumferential direction and along the inner wall surface of the base member 11, the side wall of the rotating groove 1333 approaches the locating rib 111 gradually till being stopped by the side wall such that rotation of the second ratchet wheel 133 in the circumferential direction is restricted and incapable of rotating. Under this circumstance, the preset displacement can be determined as the distance between positions of the second ratchet wheel initializing the rotation and stopping the rotation.

Besides, the switch device 10 further includes a cover plate 21 and an operation cylinder 23. The cover plate 21 is used for tightly closing an upper opening of the base member 11. The operation cylinder 23 provides a shape of “T” with the inner space thereof receiving part of the first ratchet wheel 131 and an end of the operation cylinder 23 extends outward the cover plate 21 for being turned by the user while in operation.

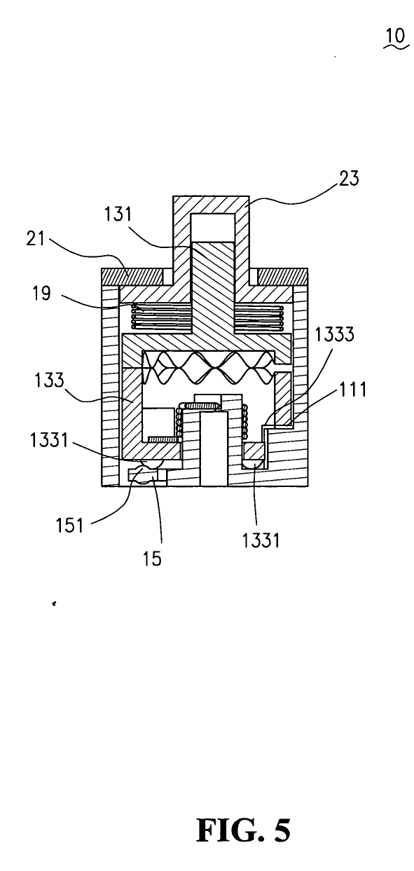

Referring to FIG. 5, once the user rotates the operation cylinder 23, the first ratchet wheel 131 is actuated to rotate and the second ratchet wheel 133 is driven by the first ratchet wheel 131. Meanwhile, the projections 1331 move to approach the vertical actuation mechanism 15 so that the contact point 151 can be pressed by the projections 1331 to produce the contact displacement in the vertical direction. Therefore, the contact displacement in the vertical direction is utilized to correspond to press button type switches 27b, 27c for performing operation of pressing the buttons.

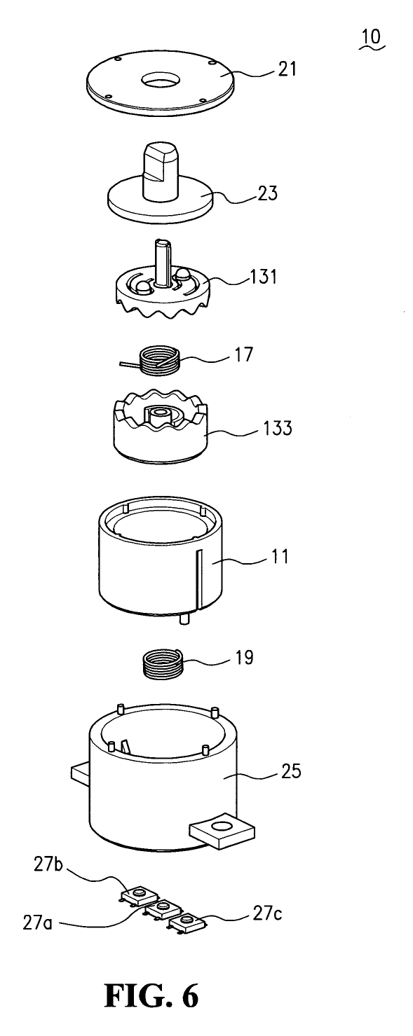

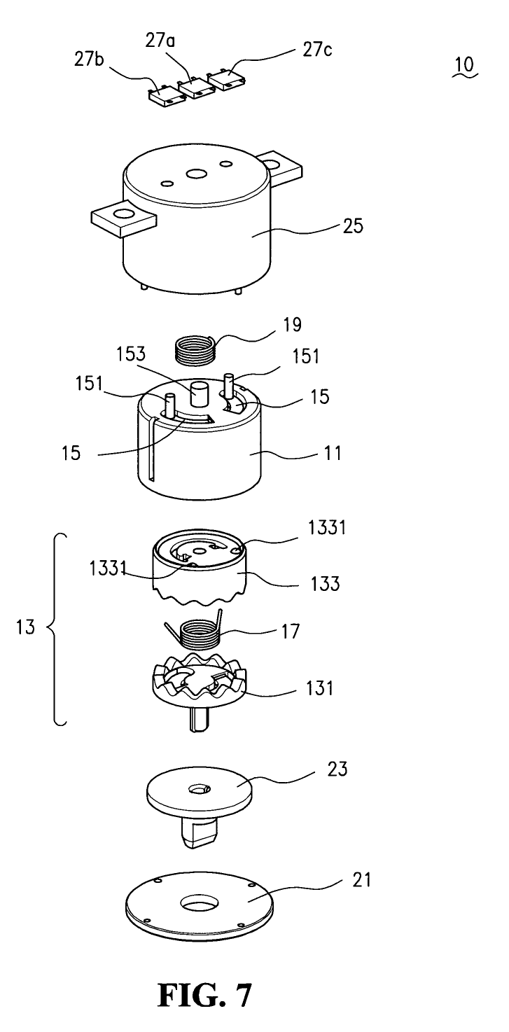

Referring to FIGS. 6 and 7, the second embodiment of a switch device according to the present invention is illustrated. The switch device 10 in FIG. 6 allows the user to press down the operation cylinder 23 and a post 153 at the base member 11 can be actuated to move downward against the push type button 27a in addition to providing rotational mechanism to offer the user rotational operation in the circumferential direction and providing pressing down mechanism to press and move a displacement for operation the switches 27b, 27c. The switch device 10 of the second embodiment further provides an outer sleeve 25 for receiving other components. Meanwhile, the base member 11 further provides a post 153 passing outward the outer sleeve 25. When the operation cylinder 23 is pressed down directly in the vertical direction, the post 153 can be moved downward to press the push type switch 27a.

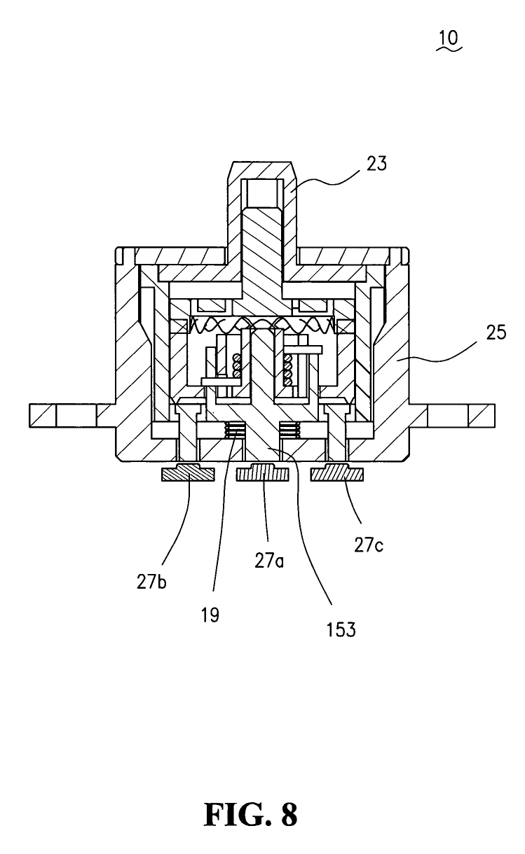

Referring to FIG. 8, the spring 19 in the second embodiment is different from that in the first embodiment and the difference is that the spring 19 connects with the post 153 and surrounding the post 153 and contacts with the base member 11 and the outer sleeve 25. The spring 19 provides a function of restoring the base member 11 and various parts displacing downward with the base member 11 to the original positions thereof.

While the invention has been described by way of examples and in terms of preferred embodiments, it is to be understood that the invention is not limited thereto. To the contrary, it is intended to cover various modifications and similar arrangements and procedures, and the scope of the appended claims therefore should be according to the broadest interpretation so as to encompass all such modifications and similar arrangements and procedures.

1. A switch device, comprising:
a base member with an open end and a closed end wall, being cylindrical, providing an axial post extending from the closed end wall therein and the closed end wall having two opposite circular grooves near the circumference thereof;
a rotary mechanism, being received in the base member for[,] being operated to move a preset circular displacement [;] and further comprising a first ratchet wheel, which is attached with a central stem, a second ratchet wheel, which meshes with the first ratchet wheel and has a bottom with a hole at the center thereof for fitting with the axial post and a plurality of semispherical projections being disposed next to the periphery thereof and spacing from each other and a torsion spring, which is disposed on the bottom of the second ratchet wheel and surrounds the axial post with an end thereof engaging with the top of the axial post and another end thereof engaging with the second ratchet wheel:
a vertical actuation mechanism, being composed of two elastic plates, which are received in the base member under the second ratchet wheel and movably disposed at the closed end wall corresponding to the two circular grooves with at least one contact point being provided at each of the elastic plates to protrude outward from two facial sides thereof[,]
a hollow handle, providing an circular plate part, which has an diameter same as the inner diameter of the open end of the base member, and a cylindrical part being fixedly attached to the stem of the first ratchet wheel for being rotated by a user;
a spring, being disposed between the first ratchet wheel and the circular plate part and surrounding the stem part for supplying a resilient force to the handle; and
a cover plates being disposed at the open end of the base member and providing a central bore for being passed through by the handle;
whereby, once the handle is turned by the user to drive the first ratchet wheel rotating a preset circular distance with the second ratchet wheel such that the projections are capable of pushing the contact points downward to press button switches underneath.

2-14. (canceled)

15. The switch device as defined in claim 1, wherein an elongated slot is provided at the top of the axial post to accommodate an end of the torsion spring and the second ratchet wheel provides a stopper formed of two parallel rectangular blocks and another end of the torsion is fixedly received in a space between the rectangular blocks.

16. The switch device as defined in claim 1, wherein the second ratchet wheel has two opposite recesses at the periphery of the bottom thereof and the base member provides two limiting ribs at the lower inner side thereof corresponding to the recesses respectively for restricting movement of the second ratchet.

17. A switch device, comprising:
An outer barrel, being cylindrical, providing an open side and a closed side, the closed side having a central fitting hole and two opposite side fitting hole and two opposite lugs with an engaging hole being provided at each of the lugs being joined to the lower circumference side thereof for being fixed to an external part;
a base member with an open end and a closed end wall, being cylindrical and received in the outer barrel, providing an axial post extending from the closed end wall therein and a first pressing post extending outward from the center of the closed end wall to pass through the central fitting hole and the closed end wall having two opposite circular grooves near the circumference thereof;
a rotary mechanism, being received in the base member for being operated to move a preset circular displacement and further comprising a first ratchet wheel, which is attached with a central stem, a second ratchet wheel, which meshes with the first ratchet wheel and has a bottom with a hole at the center thereof for fitting with the axial post and a plurality of semispherical projections being disposed next to the periphery thereof and spacing from each other, and a torsion spring, which is disposed on the bottom of the second ratchet wheel and surrounds the axial post with an end thereof engaging with the top of the axial post and another end thereof engaging with the second ratchet wheel;
a vertical actuation mechanism, being composed of two elastic plates, which are received in the base member under the second ratchet wheel and movably disposed at the closed end wall corresponding to the two circular grooves with at least one second pressing post being provided at each of the elastic plates to pass through the circular the side fitting holes and extend outward from the outer barrel;
a hollow handle, providing an circular plate part, which has an diameter same as the inner diameter of the open end of the base member, and a cylindrical part being fixedly attached to the stem of the first ratchet wheel for being rotated by a user;
a compression spring, being disposed between the outer barrel and the base member and surrounding the first pressing post for supplying a resilient force to base member; and
a cover plate, being disposed at the open end of the base member and providing a central bore for the handle extending outward.
whereby, once the handle is turned to move the preset circular displacement by the user, the base member with the ratchet wheels rotates such that the second pressing posts are capable of being pushed downward by the projections so as to press button switches underneath; and in addition, once the handle is pressed down directly, the base member is forced to move downward against the compression spring such that the first pressing post is capable of moving downward to touch a further button switch disposed under the first pressing post.
